(19) United States
(12) Patent Application Publication
(10) Pub. No.: US 2008/0137345 A1
(43) Pub. Date: Jun. 12, 2008

(54) Par² lighting fixture

(76) Inventor: Randal Lee Wimberly, Lake Havasu City, AZ (US)

Correspondence Address: Randal L. Wimberly, 905 Tyree Road, Paducah, KY, 42003, US

(21) Appl. No.: 11/638,038

(22) Filed: Dec. 12, 2006

(51) Int. Cl. F21V 7/06; B60Q 1/00

(52) U.S. Cl. 362/299; 362/368

(57) ABSTRACT

An improved lighting fixture is disclosed for imaging a high-intensity beam of light at a distant location. A specially-made duel parabolic reflector system cooperates with a gate aperture and a single aspheric lens to produce a beam that incorporates a very high proportion of emitted visible light. Alternatively, said fixture has two lenses in a positioning mechanism mounted in the housing, and includes a rack and pinion gear device that adjusts the distance between the front and rear lenses in response to the rotation of an actuator. The actuator is configured to slide along a slot in the housing, controlling the translation of the first and second lenses with respect to the gate aperture. A shielding baffle covers the slot. The actuator is further configured with a locking mechanism that constrains the actuator from being moved with respect to the housing when the locking mechanism is in position. Additionally the rear parabolic reflector part has a dichroich coating that reflects only a low proportion of infrared light. The projected beam thereby has a relatively low energy density, such that the front portion of the fixture can be reduced substantially in size, be made of light weight materials with lower temperature resistance, and utilize lenses made of plastic. The gate is selectively rotatable relative to the fixture's rear housing.

REFERENCES CITED:

| | | |
|---|---|---|
| U.S. Pat. No. 1,742,600 | January 1930 | Kliegl et al. |
| U.S. Pat. No. 1,595,533 | August 1925 | Weems |
| U.S. Pat. No. 2,650,292 | August 1953 | Strong |
| U.S. Pat. No. 3,662,165 | May 1972 | Osteen et al. |
| U.S. Pat. No. 3,704,928 | December 1972 | Coombs et al. |
| U.S. Pat. No. 3,883,733 | May 1975 | Nagel |
| U.S. Pat. No. 3,930,149 | December 1975 | French |
| U.S. Pat. No. 4,187,534 | February 1980 | Tichenor et al. |
| U.S. Pat. No. 4,240,133 | December 1980 | Haina et al. |
| U.S. Pat. No. 4,462,067 | July 1984 | Altman |
| U.S. Pat. No. 4,517,630 | May 1985 | Dieffenbach et al. |
| U.S. Pat. No. 4,519,021 | May 1985 | Oram |
| U.S. Pat. No. 4,545,000 | October 1985 | Fraley et al. |
| U.S. Pat. No. 4,609,976 | September 1986 | Geissler |
| U.S. Pat. No. 5,160,192 | November 1992 | Sugawara |
| U.S. Pat. No. 5,345,371 | September 1994 | Cunningham et al. |
| U.S. Pat. No. 5,544,029 | August 1996 | Cunningham |
| U.S. Pat. No. 6,092,914 | Jul. 25, 2000 | Esakoff, et al. |
| U.S. Patent Application | | Wimberly |
| S.N. 10/577,580. | | |

### TECHNICAL FIELD

The present invention is in the field of lighting fixtures and, more particularly, to lighting fixtures configured to project and, or, image a high-intensity beam of light at a distant location.

### BACKGROUND OF THE INVENTION

Lighting fixtures of this particular kind are commonly used in theater, television and architectural lighting applications. Many such fixtures include an ellipsoidal or near-ellipsoidal reflector with a single lamp located generally coincident with the reflector's longitudinal axis. The reflector has two general focal regions, and the lamp is positioned generally with its filaments located at or near one of those focal regions such that light emitted from the filaments is reflected by the reflector generally toward the second focal region. A gate aperture is located at that second focal region, and shutters, patterns and the like can be used at that gate for shaping the projected beam of light. A lens located beyond the gate images light passing through the gate aperture at a distant location. An alternate form of this type of lighting fixture uses two or more lens located beyond the gate to image light passing through the gate aperture at a distant location and vary the beam width of said projected beam of light.

A pair of lenses are used to project the beam of light at various beam spreads and image distances. Conventionally, the distance between each lens and the gate may be varied. In one known configuration, each lens has a control arm that may be moved to translate the lens closer to or farther from the gate. In another known configuration, one control arm translates the one lens with respect to the other, while another control arm translates the lens with respect to the two lenses. It is also known to use a rack and pinion arrangement to move lenses within a lighting fixture. In each of these arrangements, manipulation of a control to adjust a feature of the beam inherently changes another feature of the beam, and thus multiple controls must be operated, either concurrently or successively, to achieve a desired beam spread and image distance.

Another problem commonly encountered by lighting fixtures of this kind is that an excessive amount of light emitted by the lamp is not incorporated into the projected beam, but instead is misdirected and absorbed by the shutters, patterns, gate and other internal components of the fixture. This wastes electrical energy and leads to undesired heating of the fixture. In many instances, the shutters and patterns can be warped by the excessive heat and therefore need to be frequently replaced.

Another problem encountered in lighting fixtures of this kind is that the imaged light beam can sometimes have an intensity that varies such that a concentric ring pattern, or circular pattern with intense center, or oval pattern with intense longitudinal bars, or a pattern with four intense points of light energy is provided. This undesired pattern occurs because of the particular kind of filament used in the lamp, e.g., a coiled coil, biplane, or four pole longitudinal. Each point on the reflector reflects light toward the gate so as to produce a magnified image of said filament, and the superposition of the images resulting from all points on the reflector sometimes can provide these uneven patterns with hot spot areas of light energy

These undesired patterns have been overcome by providing the reflector with a plurality of small facets in varying shapes and sections, that function to blur the projected image. The facets have edges that are arranged both radially and circumferentially. Although such a reflector structure is generally effective in diminishing this effect, it is believed that this solution misdirects an excessive amount of light so as not to be incorporated into the projected beam.

Another drawback to lighting fixtures of the kind described above is that the fixture projects an undesired amount of infrared light along with the desired visible light. This unduly heats the area on which the projected light is imaged, which in the case of theater, television and some architectural lighting can lead to substantial discomfort. Reflecting undesired infrared light also leads to undesired heating of the pattern and shutters located at the gate and of any colored media or gels located forwardly of the lens. In some cases, highly absorptive media, such as blue gels, burn out very quickly or cannot be used at all. In other cases, lens made of plastic will melt or disfigure and become useless.

It should therefore be appreciated that there is a need for an improved lighting fixture that images a beam of light at a distant location to produce a smooth beam field with a conveniently adjusted variable beam spread and a variable image distance, yet that is not unduly wasteful of energy and that does not unduly transmit undesired infrared light. The present invention fulfills this need.

### SUMMARY OF THE INVENTION

Objects of the invention are to provide a lighting fixture for use in combination with a lamp in imaging a beam of light at a distant location, while utilizing a substantially greater proportion of visible light emitted by the lamp. An alternative embodiment of the fixture projects a substantially lower proportion of infrared light emitted by the lamp. Additionally the lighting fixture may be configured to have two lenses including a convenient method of adjustment to focus the beam of light at a distant location and, providing a variable beam spread and a variable image distance. A substantially more efficient lighting fixture thereby is provided.

More particularly, the fixture includes a compound concave duel parabolic reflector system having a rear reflector part with a deep substantially parabolic curve shape and a forward reflector part shaped as a zone of a shallow substantially parabolic curve having a larger parallel edge and a smaller parallel edge, said smaller edge serving as an aperture, and said larger parallel edge connected to said rear parabolic reflector part such that the focal point of said forward parabolic reflector part is also said first focus of said rear parabolic reflector part.

The fixture further includes means for supporting the lamp near the reflector's base, with the lamp's central point of light radiation substantially coincident with the reflector system's focal point. The reflector thereby reflects light emitted by the lamp to form a beam that is imaged at a predetermined location.

Further, the lamp position is conveniently adjusted relative to the reflector system focal point using two knobs mounted on the rear assembly that supports the lamp. One knob moves the lamp along the fixture's longitudinal axis, while the other knob, when loosened, allows the lamp's transverse position relative to that axis to be selected. When replacing a burned out lamp, removing and replacing the lamp assembly from the remainder of the fixture does not affect the lamp's position adjustment.

The majority of light coming from the lamp placed substantially at the focal point of the reflector system takes one of three paths. First, light shining towards the aperture of the light reflector system exits directly. Second, light shining towards the forward parabolic reflector part is reflected towards the rear parabolic reflector part. Third, light shining towards the rear parabolic reflector part is reflected forward where it either exits the reflector system through the aperture or hits the forward parabolic reflector and is reflected back and forth between said rear parabolic reflector part and said forward parabolic reflector part until it moves inward toward the focal point and becomes in alignment with the aperture and exits said reflector system.

In another feature of the invention, a gate aperture is positioned beyond the front parabolic reflector part aperture, for use in defining the peripheral shape of the imaged light beam. A lens positioned beyond the gate images the light at the distant location.

In yet another feature of the invention, The rear parabolic reflector part may also be coated in a manor as to make it reflect visible light and allow heat or infrared energy to pass through.

In an alternative embodiment of the invention, the reflector is constructed of borosilicate glass coated with multiple thin-film layers of a dielectric coating, which has a substantially higher reflectance at visible wavelengths than at infrared wavelengths. This minimizes the amount of projected infrared light and thereby minimizes undesired heating of objects located at the site of the imaged beam. It also limits the amount of radiant energy passing through one or more colored media or gels located forward of the lens, thereby allowing the sizes of those gels, as well as the size of the lens, to be substantially reduced. Minimizing the amount of reflected infrared light also reduces undesired heating of the shutters, patterns, front barrel, and lenses of the fixture making it possible to manufacture some of these parts in lightweight plastics materials.

In still another feature of the invention, the lens for imaging the projected light includes a single, aspheric lens configured to substantially correct spherical aberration, astigmatism and field curvature in the projected image. Because just a single lens element is required, the total reflection loss occurring at the lens surfaces can be reduced significantly from that occurring in prior fixtures, which typically included two spherical lenses.

In still another feature of the invention, the lens is made of plastic and configured either as a flat or curved aspheric Fresnel lens. When the lighting fixture is configured to project a beam of relatively narrow beam width, a flat Fresnel lens can be used. In such cases, the Fresnel lens is located relatively far from the gate aperture, and it can be formed of acrylic. When greater beam widths are desired, a curved Fresnel lens, also called a stepped aspheric lens, must be used. In such cases the lens ordinarily is moved relatively closer to the gate aperture, so a plastic having a higher heat tolerance, e.g., polycarbonate, ordinarily must be used.

In yet another feature of the invention, a shutter/pattern assembly located at the fixture's gate aperture is carried by a front barrel assembly that is selectively rotatable relative to a rear housing for the concave reflector and lamp. This facilitates a convenient shaping of any selected part of the projected beam.

Additionally, the heat radiated from the front of the lamp light source can be reduced by placing a hot mirror or hot mirror coated lens in the front of the opening aperture of the reflector system to reflect the heat and allow the visible light to pass through.

Additionally, the quality of the projected beam of light can be enhanced by making the reflective surface of the reflector sections to include a plurality of facets, rings, or fluted areas. Additionally the reflector surface may be given texture such as, but not limited to, sand blasting and bead blasting. These areas are arranged substantially uniformly around its circumference, functioning to redirect the light in a way that provides the imaged beam with a desired intensity distribution, while redirecting very little of the light outside the image spot. The reflector surface output may then be increased by various surface coatings such as, but not limited to, chemical bright dipping, dichroich coating, enhanced aluminum coating, and vacuum metalizing.

In another alternative embodiment of the invention, the lighting fixture includes two lenses or optical components providing a variable beam spread and a variable image distance. A single, conveniently adjusted, positioning mechanism is configured in a first independent degree of freedom to control the position of the first and second optical components with respect to the gate aperture, while also being configured in a second independent degree of freedom to adjust the distance between the first optical component and the second optical component. The positioning mechanism is also configured with a locking position that allows the optical components to be maintained in the user selected positions.

This permits a conveniently adjusted lighting fixture having lower power consumption in a more compact form and a system that can be higher in power but not as harmful to lens made of plastic, or the media that it is projecting, or objects that are in the projected beam path.

Still further advantages of the present invention will become apparent to those of ordinary skill in the art upon reading and understanding the following detailed description of the preferred embodiments.

### BRIEF DESCRIPTION OF THE DRAWING

The preferred embodiments of the present invention will hereinafter be described in conjunction with the appended drawings, where like designations denote like elements, and:

FIG. 1 is a schematic diagram of a first embodiment of a lighting fixture in accordance with the invention, including an incandescent halogen lamp, lamp adjustment mechanism, and a reflector system with a deep parabolic rear section joined with a shallow parabolic front section including the system aperture.

FIG. 2 is a schematic diagram of an alternate embodiment of a lighting fixture in accordance with the invention, including an incandescent halogen lamp, lamp adjustment mechanism, a reflector system with a deep parabolic rear section joined with a shallow parabolic front section including an aperture, a gate, and a collimating lens.

FIG. 3 is a schematic diagram of another alternate embodiment of a lighting fixture in accordance with the invention, including a discharge lamp, lamp adjustment mechanism, a reflector system with a deep parabolic rear section joined with a shallow parabolic front section, a gate, and two lenses including a convenient adjustment mechanism to provide a variable beam spread and a variable image distance.

### DETAILED DESCRIPTION OF THE INVENTION

Reference will now be made in detail to the present preferred embodiment of the invention, examples of which are illustrated by the accompanying drawings. While the invention will be described in connection with a preferred embodiment, it will be understood that it is not intended to limit the invention to that embodiment.

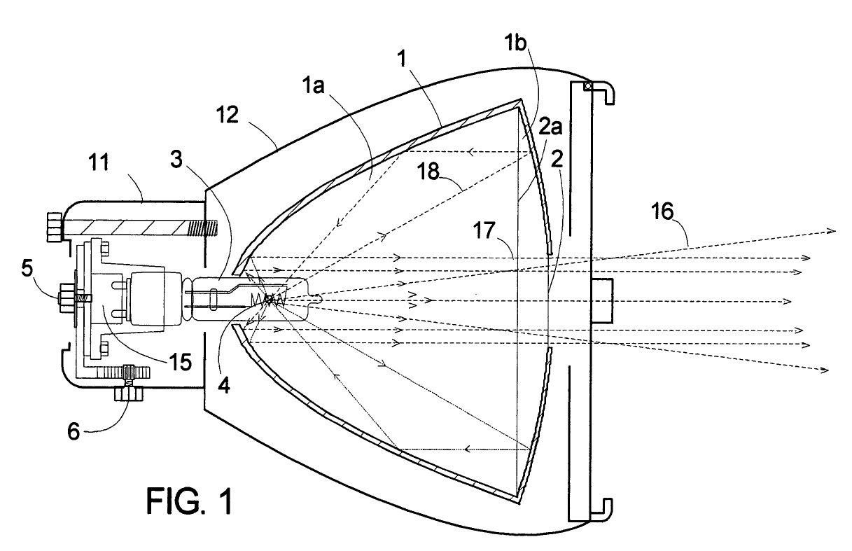

FIG. 1 is a schematic diagram of a first embodiment of a lighting fixture in accordance with the invention. The fixture includes a compound concave duel parabolic reflector system 1 having a rear reflector part 1a with a deep substantially parabolic curve shape and a forward reflector part 1b shaped as a zone of a shallow substantially parabolic curve having a larger parallel edge 2a and a smaller parallel edge, said smaller edge serving as an aperture 2, and said larger parallel edge 2a connected to said rear parabolic reflector part 1a such that the focal point 4 of said forward parabolic reflector part 1b is also said first focus 4 of said rear parabolic reflector part 1a.

The fixture includes a removable lamp support assembly 11 for supporting a halogen lamp 3 near the reflector's base, with the lamp's center point of light radiation substantially coincident with the reflector system focal point 4.

The lamp 3 position is conveniently adjusted relative to the reflector system focal point 4 using two independent means of adjustment on the rear assembly 11 that supports the lamp. One means of adjustment is a knob 5, that when loosened, allows the lamp's transverse position relative to that axis to be selected. The other means of adjustment is a knob 6 that utilizes a rack and pinion mechanism to move the lamp along the fixture's longitudinal axis. This provides for removal and replacement of the lamp support assembly 11 from the remainder of the fixture 12 without affecting the lamp's position adjustment.

This provides a system whereby the majority of light coming from the lamp 3 placed substantially at the focal point 4 of the reflector system 1 is projected in a useful manner. The light generated by the lamp 3 takes one of three paths. First, light 16 shining towards the aperture 2 of the light reflector system 1 exits directly. Second, light 17 shining towards the rear parabolic reflector part 1a is reflected forward where it either exits the reflector system 1 through the aperture 2 or hits the forward parabolic reflector part 1b and is reflected back towards said rear parabolic reflector part 1a. Third, light 18 shining towards the forward parabolic reflector part 1b is reflected back and forth between said rear parabolic reflector part 1a and said forward parabolic reflector part 1b until it moves inward toward the focal point 4 and becomes in alignment with the aperture 2 and exits said reflector system 1.

The reflector system 1 thereby reflects light emitted by the lamp 3 to form a beam that is imaged at a predetermined location

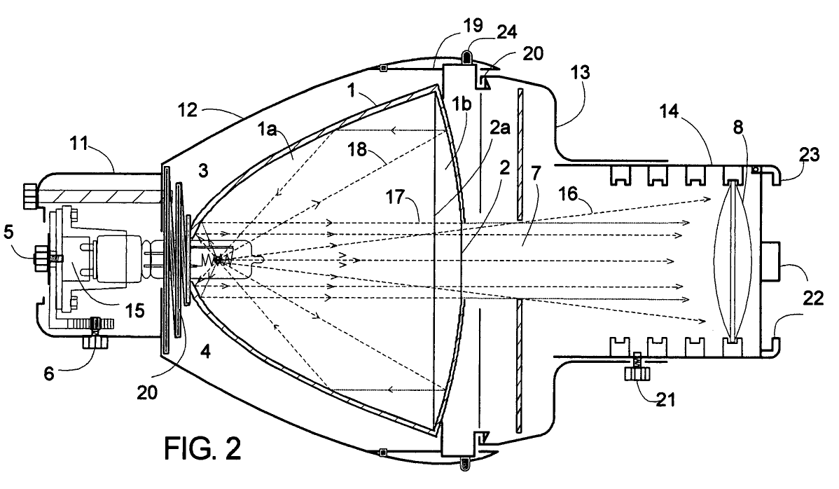

FIG. 2 is a schematic diagram of an alternate embodiment of a lighting fixture in accordance with the invention. This embodiment includes all of the parts listed for FIG. 1 with the addition of a gate assembly positioned beyond the aperture of the reflector system and a lens assembly positioned beyond the gate to image the light at a distant location.

A generally cylindrical front barrel 13 and a lens tube 14 are secured to the forward end of the rear housing 12. A gate 7 assembly is housed in the rear of the front barrel 13, and the lens tube 14 includes a lens 8 installed at one of several factory-selected locations along its length. The lens tube further includes guides 22 and a pivotable retainer 23 for retaining one or more colored media or lighting accessories at its forward end. Light emitted by the lamp 3 is reflected by the reflector system 1 through the gate assembly to the lens 8, which forms a beam that is projected through the media and away from the fixture. Different lenses installed at factory-selected lens positions allow for selection of the projected beam's field angle, typically ranging from as little as 5.degrees to as high as 50.degrees or more.

The front barrel 13 and lens tube 14 are configured to be telescopically slidable relative to each other. This enables the lens 8 to be selectively positioned relative to the gate 7, so as to image the beam at a selected range. Elongated Teflon guides secured to the outer side of the lens tube are received within correspondingly shaped V tracks in the inner side of the front barrel. The guides and tracks are oriented longitudinally, to allow the lens tube to be slid manually to a selected longitudinal position relative to the front barrel. A set screw with an enlarged head 21 for manual gripping can be tightened to lock the lens tube in its selected position.

The reflector system 1 is supported within the rear housing 12 by a large coil spring 20 and retained in the front by spring clips 19. This spring mounting allows for differential thermal expansion and also provides improved shock absorption for the reflector.

In another feature of the invention, the reflector system 1 is made of aluminum with the rear parabolic reflector part 1a having a dichroich characteristic, reflecting a very high proportion of visible light, while transmitting a very high proportion of infrared light. The reflector is given a special, multiple-layer, thin-film dielectric coating. The front shallow parabolic reflector part 1b is given a hot mirror reflector coating that reflects both visible and infrared light.

Configuring the reflector system 1 as described above, ensures that a much higher proportion of the projected light leaving the reflector system 1 aperture 2 is in the visible spectrum, and thus useful. Only about 10% of the emitted infrared light is projected. Moreover, the dichroich coated aluminum reflector reflects about 95% of visible light, which is substantially higher than prior polished aluminum reflectors.

In addition, reducing the amount of forwardly-directed infrared light reduces correspondingly the undesired heating of the fixture's front barrel 13 and lens tube 14, including the shutter/pattern assembly located at the gate 7, the lens 8, and colored media. This, in turn, allows these components to be made smaller, and thus lighter and less expensive to manufacture, without bringing about an excessively high energy density. This also makes it possible to manufacture these components using lower cost, lightweight plastics materials.

The lens 8 preferably is configured to be a single aspheric lens, which substantially corrects spherical aberration, astigmatism, and field curvature in the projected beam. This has several advantages over prior lens systems that included multiple plano-convex lenses with one spherical surface each. Because just a single lens is included, reflection losses are dramatically reduced and efficiency therefore is increased.

As previously mentioned, the gate 7 including the shutter/pattern assembly, is located at the rearward end of the front barrel 13, which is substantially beyond the reflector system 1 aperture 2. The projected beam's cross-section can be shaped at this location, and that same shape is then imaged at the distant location. To facilitate this shaping, four circumferentially-oriented are formed in the front barrel and sized to slidably receive four shutters configured to be selectively slidable into the path of the beam being projected. One of the slots is sized also to slidably receive a pattern configured to be selectively slidable into the path of the beam.

In the past, the ability to shape selected portions of the beam being projected was limited, because shutters typically were insertable into the beam's path from only four angularly fixed positions. Although the shutters could each be tilted and rotated to a limited extent, they could not be tilted sufficiently to allow complete freedom in the shaping of the projected beam. Some fixtures have the ability to rotate the front barrel by a limited number of degrees. In this embodiment of the invention, however, this drawback is overcome by configuring the front barrel 13 to be selectively rotatable by .+−.360 degrees relative to the rear housing 12.

Rotation of the front barrel 13 relative to the rear housing 12 is accomplished by means of a cylindrical lip 20 projecting rearwardly from the barrel and sized to slidably fit within the forward part of the rear housing 12. The rearward end of this cylindrical lip 20 is received into retaining spring clips 19 attached to the rear housing 12 and shaped to automatically snap into position and lock the front barrel 13 to the rear housing 12. The retaining spring clip 19 has a pin 24 protruding thru an opening in the rear housing 12 allowing the front barrel 13 to be easily released for maintenance by a user pressing on the pins 24. Retaining spring clip 19 tension is designed to be tight enough to limit unwanted rotation of the front barrel 13 but loose enough for the user to rotate the front barrel 13 with moderate pressure.

Provision for an annular space encircling the reflector system 1 and numerous ventilation openings in the rear housing 12, lamp support assembly 11, and front barrel 13 ensure that the lighting fixture is adequately cooled. A power cable supplies electrical current to the lamp 3.

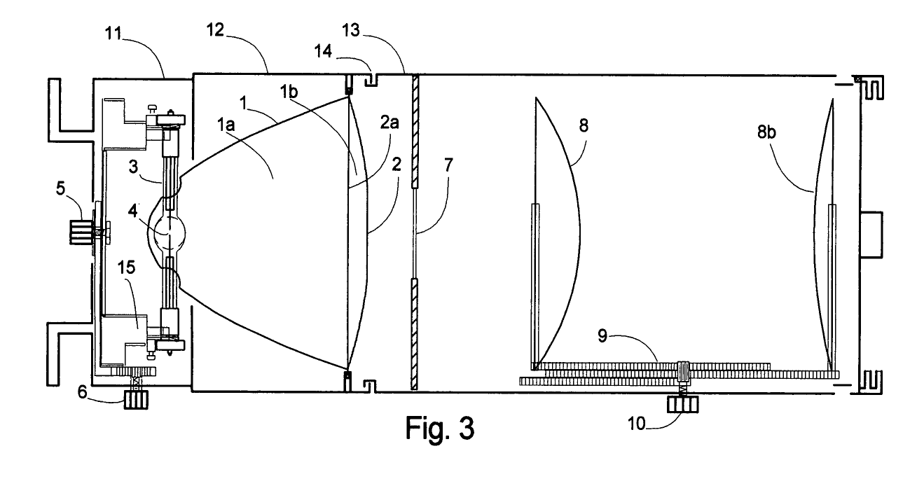

FIG. 3 is a schematic diagram of another alternate embodiment of a lighting fixture in accordance with the invention.

The fixture includes a compound concave duel parabolic reflector system 1 having a rear reflector part 1a with a deep substantially parabolic curve shape and a forward reflector part 1b shaped as a zone of a shallow substantially parabolic curve having a larger parallel edge 2a and a smaller parallel edge, said smaller edge serving as an aperture 2, and said larger parallel edge 2a connected to said rear parabolic reflector part 1a such that the focal point 4 of said forward parabolic reflector part 1b is also said first focus 4 of said rear parabolic reflector part 1a.

The fixture includes a removable lamp support assembly 11 for supporting lamp socket 15 and a duel ended discharge lamp 3 near the reflector's base, with the lamp's center point of light radiation substantially coincident with the reflector system focal point 4.

The lamp 3 position is conveniently adjusted relative to the reflector system focal point 4 using two independent means of adjustment on the rear assembly 11 that supports the lamp. One means of adjustment is a knob 5, that when loosened, allows the lamp's transverse position relative to that axis to be selected. The other means of adjustment is a knob 6 that utilizes a rack and pinion mechanism to move the lamp along the fixture's longitudinal axis. This provides for removal and replacement of the lamp support assembly 11 from the remainder of the fixture 12 without affecting the lamp's position adjustment.

This provides a system whereby the majority of light coming from the lamp 3 placed substantially at the focal point 4 of the reflector system 1 is projected in a useful manner.

In another feature of the invention, the front shallow parabolic part 1b of the reflector system 1 is made of aluminum with the rear parabolic reflector part 1a made of borosilicate glass having a dichroich characteristic, reflecting a very high proportion of visible light, while transmitting a very high proportion of infrared light. The deep rear reflector part 1a is given a special, multiple-layer, thin-film dielectric coating. The front shallow parabolic reflector part 1b is given a hot mirror reflector coating that reflects both visible and infrared light.

Configuring the reflector system 1 as described above, ensures that a much higher proportion of the projected light leaving the reflector system 1 aperture 2 is in the visible spectrum, and thus useful. Only about 10% of the emitted infrared light, which would serve only to heat the objects being illuminated, is projected. Moreover, the dichroich coated aluminum reflector reflects about 95% of visible light, which is substantially higher than prior polished aluminum reflectors.

In addition, reducing the amount of forwardly-directed infrared light reduces correspondingly the undesired heating of the fixture's front barrel 13 including the shutter/pattern assembly located at the gate 7, the adjustable lens optics system 8, 8b, 9, and 10, and colored media. This, in turn, allows these components to be made smaller, and thus lighter and less expensive to manufacture, without bringing about an excessively high energy density. This also makes it possible to manufacture these components using lower cost, lightweight plastics materials.

A generally cylindrical front barrel 13 including an adjustable lens optics system 8, 8b, 9, and 10 is secured to the forward end of the rear housing 12. A gate 7 including the shutter/pattern assembly, is located at the rearward end of the front barrel 13, which is substantially beyond the reflector system 1 aperture 2. The projected beam's cross-section can be shaped at this location, and that same shape is then imaged at the distant location. To facilitate this shaping, four circumferentially-oriented are formed in the front barrel and sized to slidably receive four shutters configured to be selectively slidable into the path of the beam being projected. One of the slots is sized also to slidably receive a pattern configured to be selectively slidable into the path of the beam.

In the past, the ability to shape selected portions of the beam being projected was limited, because shutters typically were insertable into the beam's path from only four angularly fixed positions. Although the shutters could each be tilted and rotated to a limited extent, they could not be tilted sufficiently to allow complete freedom in the shaping of the projected beam. Some fixtures have the ability to rotate the front barrel by a limited number of degrees. In this embodiment of the invention, however, this drawback is overcome by configuring the front barrel 13 to be selectively rotatable by .+−.360 degrees relative to the rear housing 12.

Rotation of the front barrel 13 relative to the rear housing 12 is accomplished by means of a cylindrical lip 20 projecting rearwardly from the barrel and sized to slidably fit within the forward part of the rear housing 12.

The front barrel 13 includes two lenses or optical components providing a variable beam spread and a variable image distance. A single spring loaded knob 10 conveniently adjusts the positioning mechanism and is locked in place until pressed in toward the center of the barrel. When pressed in and pulled or pushed along the longitudinal axis of the fixture, the knob is configured in a first independent degree of freedom to control the position of the first 8 and second 8b optical components with respect to the gate aperture 7 by sliding the entire positioning mechanism 8, 8b, 9, &10 along a grooved track in the front barrel 13 housing. When the knob is pressed in and turned it is configured in a second independent degree of freedom to adjust the distance between the first optical component 8 and the second optical component 8b by actuating a duel rack and pinion system 9. The positioning mechanism 8, 8b, 9, &10 is locked in place when the spring loaded knob 10 is released allowing the optical components to be maintained in the user selected positions.

In still another feature of the invention, the lens may be made of glass or plastic and configured as a flat or curved aspheric Fresnel lens, Plano convex, spherical, or aspheric lens configured to substantially correct spherical aberration, astigmatism and field curvature in the projected image.

Light emitted by the lamp 3 is reflected by the reflector system 1 through the gate 7 assembly to the adjustable lens optics system 8, 8b, 9, and 10 which forms a beam that is projected through the media and away from the fixture

This permits a conveniently adjusted lighting fixture having lower power consumption in a more compact form and a system that can be higher in power but not as harmful to lens made of plastic, or the media that it is projecting, or objects that are in the projected beam path.

What is claimed is:

1. A lighting fixture for imaging a beam of light at a distant location, comprising:
a concave reflector system configured to be substantially symmetrical about a longitudinal axis wherein said reflector system has a rear reflector part having a deep substantially parabolic curve shape and a forward reflector part shaped as a zone of a shallow substantially parabolic curve having a larger parallel edge and a smaller parallel edge, said smaller edge serving as an aperture, and said larger parallel edge connected to said rear parabolic reflector part such that the focal point of said forward parabolic reflector part is also said first focus of said rear parabolic reflector part;
a housing for supporting the reflector;
a lamp including a finite light or energy source with the approximate center of said light or energy source placed substantially at the focal point of the said reflector system; and
a lens located beyond the aperture of the front reflector part section
wherein a substantial portion of the light emitted by the lamp impinges on, and is redirected by, the reflector system to project a beam of light substantially parallel with the longitudinal axis of the reflector system.

2. A lighting fixture as defined in claim 1, wherein said reflector system rear reflector part having a deep substantially parabolic curve shape surface is coated with a material, or made in a way, that allows the infrared and heat energy of the light source to pass through but reflects the visible spectrum of the light source.

3. A lighting fixture as defined in claim 1, wherein the front lens is coated with a material or made in a way that allows the infrared and heat energy of the light source to be reflected but allows the visible spectrum of the light source to pass through.

4. A lighting fixture as defined in claim 1, wherein the light source is selected from the group consisting of halogen, discharge, and semiconductor light sources.

5. A lighting fixture as defined in claim 1, wherein the lens is made of plastic.

6. A lighting fixture as defined in claim 1, wherein the means for supporting the lamp includes:
a rear mounting bracket or plate;
means for securing said bracket or plate to the housing;
a socket for holding the lamp attached to said bracket or plate;
manual adjustment means for selectively positioning the socket transversely of the reflector's longitudinal axis without affecting the socket's axial position; and
manual adjustment means for selectively positioning the socket axially relative to the reflector's longitudinal axis without affecting the socket's transverse position;
wherein operation of the said means for securing does not affect the transverse and axial adjustment means.

7. A lighting fixture as defined in claim 1, wherein the reflector system is made of a material selected from the group consisting of metal, glass, ceramic, and plastic.

8. A lighting fixture as defined in claim 1, wherein the rear housing includes a spring loaded reflector mounting means for engaging the reflector at its base and, or, its mouth, to secure the reflector within the housing.

9. The lighting fixture as defined in claim 1 wherein the inside of said rear parabolic reflector part has a surface that consist of facet shapes selected from the group of radial rings with convex surfaces calculated to each have a different radius, radial rings of concave facets, radial rings of flat facets, longitudinal convex facets, longitudinal concave facets, longitudinal flat facets, trapezoidal convex facets, trapezoidal concave facets, and trapezoidal flat facets: and
said facet surfaces to be selected from the group of mirror, matte, machine, sand blasted, and bead blasted.

10. A lighting fixture for imaging a beam of light at a distant location, comprising:
a concave reflector system configured to be substantially symmetrical about a longitudinal axis wherein said reflector system has a rear reflector part having a deep substantially parabolic curve shape and a forward reflector part shaped as a zone of a shallow substantially parabolic curve having a larger parallel edge and a smaller parallel edge, said smaller edge serving as an aperture, and said larger parallel edge connected to said rear parabolic reflector part such that the focal point of said forward parabolic reflector part is substantially the said first focus of said rear parabolic reflector part;
a housing for supporting the reflector;
a lamp including a finite light or energy source;
means for supporting the lamp adjacent the base of the concave reflector system with the approximate center of said light or energy source placed substantially at the focal point of the said reflector system;
a gate aperture located beyond the aperture of the front reflector part section;
a generally cylindrical front barrel having a longitudinal axis;
means for securing the front barrel to the rear housing with the longitudinal axis of the front barrel substantially coincident with the longitudinal axis of the reflector; and
one or more shutters or patterns slidably received in the front barrel, substantially at the gate aperture, and selectively slidable into the path of light passing therethrough;
means for securing the front barrel configured to allow the front barrel to be selectively rotatable relative to the rear housing, about the barrel, such that the shutter can intercept a selected portion of the light passing therethrough;
a generally cylindrical lens tube telescopically received within the front barrel; and
a single aspheric lens that substantially corrects spherical aberrations, astigmatism, and field curvature in the projected beam is located within the lens tube, said lens having a predetermined focal length and positioned beyond the gate aperture by a distance corresponding generally to said focal length, such that the lens images the light passing through the gate aperture at a distant location;
wherein the lens tube is configured to be controllably movable along its longitudinal axis, to position the lens a selected distance from the gate aperture and thereby to controllably adjust the distance at which the light projected by the lens is imaged.

11. A lighting fixture as defined in claim 10, wherein said reflector system rear reflector part having a deep substantially parabolic curve shape surface is coated with a material or made in a way that allows the infrared and heat energy of the light source to pass through but reflects the visible spectrum of the light source.

12. A lighting fixture as defined in claim 11, wherein the lens is made of plastic.

13. A lighting fixture as defined in claim 10, wherein the lens is coated with a material or made in a way that allows the infrared and heat energy of the light source to be reflected but allows the visible spectrum of the light source to pass through.

14. A lighting fixture as defined in claim 10, wherein the light source is selected from the group consisting of halogen, discharge, and semiconductor light sources.

15. A lighting fixture as defined in claim 10, wherein the means for supporting the lamp includes:
a rear mounting bracket or plate;
means for securing said bracket or plate to the housing;
a socket for holding the lamp attached to said bracket or plate;
manual adjustment means for selectively positioning the socket transversely of the reflector's longitudinal axis without affecting the socket's axial position; and
manual adjustment means for selectively positioning the socket axially relative to the reflector's longitudinal axis without affecting the socket's transverse position;
wherein operation of the said means for securing does not affect the transverse and axial adjustment means.

16. A lighting fixture as defined in claim 10, wherein the reflector system is made of a material selected from the group consisting of metal, glass, ceramic, and plastic.

17. A lighting fixture as defined in claim 10, wherein the rear housing includes a spring loaded reflector mounting means for engaging the reflector at its base and, or, its mouth, to secure the reflector within the housing.

18. A lighting fixture as defined in claim 10, wherein the front barrel and lens tube is made of a material selected from the group consisting of metal, plastic, carbon fiber, and synthetic fiber.

19. A lighting fixture as defined in claim 10, wherein the inside of said rear parabolic reflector part has a surface that consist of facet shapes selected from the group of radial rings with convex surfaces calculated to each have a different radius, radial rings of concave facets, radial rings of flat facets, longitudinal convex facets, longitudinal concave facets, longitudinal flat facets, trapezoidal convex facets, trapezoidal concave facets, and trapezoidal flat facets: and
said facet surfaces to be selected from the group of mirror, matte, machine, sand blasted, and bead blasted.

20. A lighting fixture as defined in claim 10, including:
a second lens optical component configured to receive light transmitted by the first lens optical component and project it at the distant location to image the light;
a positioning mechanism mounted on the housing and configured to control the position of the first and second optical components with respect to the gate aperture and with respect to each other, the positioning mechanism having an actuator;
wherein the actuator is configured to be moved relative to the housing in a first independent degree of freedom to adjust the distance between the first optical component and the second optical component; and
wherein the actuator is configured to be moved relative to the housing in a second independent degree of freedom to adjust the relative distance between the aperture and the first and second optical components:
to position the lenses at a selected distance from the gate aperture and thereby to controllably adjust the distance at which the light projected by the lenses is imaged. and to position the said lenses at a selected distance from each other and thereby to controllably adjust the beam width of the said light projected by the said lenses.
